(19) United States
(12) Patent Application Publication
(10) Pub. No.: US 2005/0018030 A1
(43) Pub. Date: Jan. 27, 2005

(54) Printed cloth

(76) Inventors: Alan Brasier, Stonehouse (GB); Stuart Gardiner, Yate (GB)

Correspondence Address: MILLIKEN & COMPANY, 920 MILLIKEN RD (M-495), PO BOX 1926, SPARTANBURG, SC, 29304, US

(21) Appl. No.: 10/495,698

(22) PCT Filed: Nov. 22, 2002
(86) PCT No.: PCT/GB02/05265

(30) Foreign Application Priority Data
Nov. 23, 2001 (GB) 0128114.6
Nov. 23, 2001 (GB) 0128119.5

(51) Int. Cl. B41J 2/01

(52) U.S. Cl. 347/105

(57) ABSTRACT

A gaming or cue-sports cloth comprises a major part by weight of wool, which comprises base fibres and surface fibres that form an upper surface of the cloth. The base fibres and the surface fibres are bulk dyed to a substantially uniform colour and, in addition, at least some of the surface fibres are provided with a graphic image using ink suitable for wool and blends thereof.

This invention relates to the application of inkjet printing technology to produce pictorial layouts and logos for use on gaming and cue-sports tables, in particular it relates to use of the technology on pre-dyed substrates, most particularly cue sports cloth.

It is known to print on dyed woollen casino cloth for use on gaming tables using a process in which the cloth is dyed with a fugitive dye and then a print paste including a discharge agent capable of releasing the fugitive dye is silk screen printed onto the cloth, thereby removing the fugitive dye and replacing it with a new colour. Such a process is described in GB 2311079. There are several problems with the use of this process. The silk screen process is cumbersome because it necessitates the printer having to keep multiple silk screens for each layout of cloth that may be desired by a customer. It also gives a comparatively poor definition product and has limited imaging capability. The original fugitive dye must also be selected with care and this can increase the cost of the product.

There is also known a process for printing onto polyester cloths in which a design is transfer printed onto the surface of the polyester from a paper substrate by means of a sublimation process, the design having been printed onto the paper. This type of process cannot be used for wool or wool blends containing a major proportion of wool. Polyester cloths are less suitable for pool or snooker table use than wool based cloths because they do not resist soiling or cigarette burns as effectively. Polyester cloth is also regarded as an inferior product to woollen cloth for the casino market.

It is known to use inkjet-printing technology for textile sample manufacture. Inks are available containing dyestuffs that are suitable for both wool and silk. Generally, direct printing techniques are used for mass produced designs. There is an unmet need for a better printing process for use with woollen cloths, especially one that can be used for “mass customisation”.

According to the present invention there is provided a dyed cloth comprising a major part by weight of wool, which comprises base fibres and surface fibres that form an upp er surface of the cloth, in which the base fibres and the surface fibres are bulk dyed to a substantially uniform colour and, in addition, at least some of the surface fibres are provided with a graphic image using ink suitable for wool and blends thereof.

The cloth may be over-printed with a graphic image using ink selected from classes suitable for wool and polyamides and blends thereof after bulk dying the cloth. Preferably the cloth contains about at least 60%, most preferably at least 70%, wool if it is a worsted yarn construction or at least 70%, most preferably at least 80%, wool if it is a woollen yarn construction. In the case of a wool/polyamide blend, the cloth may contain at least about 70%, preferably at least about 80% wool and at most about 30%, preferably at most about 20%, polyamide.

The ink may include coloring agents selected from reactive dyes, acid dyes, pigments and mixtures thereof or any other suitable coloring agent which has been chosen to be compatible with the dyed cloth. The overprinted cloth is advantageously used for gaming or cue-sports tables. In the case of casino cloth the overprinting avoids the prior art disadvantages of having to discharge the bulk dye. In the case of cue sports cloth the overprinting may reduce the visibility of cue stabs when compared to their visibility on a printed cloth which has not been bulk dyed to a graphic image complimentary shade in advance.

We have found that a problem with surface printed white or natural woollen cloth is that, when it is used for a cue sports table cover, it can become unsightly rather quickly due to damage caused by a cue tip contacting the cloth. This damage occurs on all cue sports tables but it becomes particularly apparent when the fabric has been surface printed over a white or natural base cloth. The problem of cue stabs also occurs with worsted wool nylon blended cloths, but to a lesser extent than for 100% woollen felted and napped cloths.

By selection of the colour of the bulk dyed base cloth the visibility of the cue stabs can be much reduced when compared with what would have been the case on a white or natural cloth which has not been bulk dyed. We have found that there is an optimum shade for the bulk dyed cloth. Too light and it does not sufficiently mask the cue stab damage whereas too dark and it makes it difficult to get any significant pattern overprinted onto it. This is because the overprinting is only able to add, and thereby darken, the bulk dyed colour.

Advantageously the overprinting is carried out using a computer controlled digital printer with one or more travelling print heads. This enables the design to be changed easily from one piece of cloth to another, or even along a roll of cloth. It also reduces the amount of equipment needed to produce a variety of designs in comparison with the prior art screen printing processes. Overprinting using a computer controlled digital printer gives the option to alter designs frequently in a cost-effective manner.

The cloth is preferably felted and is usually selected from felted woven woollen; felted non-woven woollen and worsted cloth. Preferably it is woven as this gives a hardwearing high quality surface which is particularly good for printing on because it does not deteriorate much during use.

After printing with inks containing dyestuffs, the cloth is preferably steamed to react the dyestuff to the cloth fibres and then washed to remove excess dyestuff. This gives a good dye substantivity, which in turn gives the required high degree of cleanability and durability to the product. When inks containing pigments are used the need for fixing in this way may be reduced or even eliminated. The product may be gaming cloth, also known as casino cloth or a cue-sports cloth. Cue sports cloth includes cloth used to cover tables on which one or more of the games of snooker, pool, billiards and any other cue sports game may be played.

The present invention also comprises the use of a cloth as described in the preceding statements of invention, wherein the surface fibres provide a playing surface for a cue sports table. The surface fibres preferably provide a playing surface for a casino table.

According to a further aspect of the present invention there is provided a process for manufacture of a gaming or cue-sports cloth comprising the steps of feeding a bulk dyed woven woollen or worsted cloth or a felted woollen needle fabric to an inkjet printing machine then using the machine to print the top surface of the cloth with ink to generate a graphic design on at least part of the top surface that contrasts visibly with the unprinted bulk dyed cloth, which fulfils a requestor's expressed design wish.

Advantageously, the process includes using the inkjet printing machine to overprint the cloth to generate a pattern or design which fulfils a customer's expressed design wish, then shipping the cloth to the customer. This enables the achievement of a combination of the quality of a woollen cloth with the convenience of transfer printed polyester fabrics. Furthermore it offers the opportunity to produce dyed woollen pool cloth which has been overprinted with patterns simulating other materials to create innovative novel patterns and colour effects. Preferably a number of designs are printed onto a roll of fabric which is then cut to size for the individual customer. It is less preferred for these applications, but it is also possible to use a cloth made from a woollen worsted yarn.

By “feeding” we mean supplying the cloth to the printer by any means including, for example, hand feeding and machine feeding.

Optionally the cloth can have a finish applied to it after printing.

A further advantage of this process is that it enables mass customisation for casino cloth as well as for pool cloth. It is possible using the process according to the present invention to create casino layouts from scratch.

The invention will now be further described with reference to the following non-limiting illustrative examples:

### EXAMPLE 1

A felted woollen woven cloth on a 55 m roll was produced using a conventional felting and finishing process, which optionally includes face finishing. The cloth may be chlorinated to improve the dye absorbency of the wool before dying it blue as normal. Print fixation chemicals were applied by padding. The invention contemplates improvements in this technology whereby the entire printing ink formulation may be applied through the print head. The fabric was then dried before passing it through a digital printing machine with the capability of applying multiple colours of acid dye based ink. A design motif was printed onto the cloth at intervals suitable for its eventual use as pool cloths. The cloth was then subjected to a steam fixation process and then washed and dried before going forward to a conventional dry finishing process comprising cropping and brushing as appropriate for the desired end product.

### EXAMPLE 2

A non-woven needle-felted woollen casino cloth containing 90% wool and 10% polyamide was printed in a similar way to example 1 except that the printing pattern chosen was appropriate for a casino cloth an depicted a popular casino game ready to be laid onto the table at the casino. A number of similar cloths with different games were printed sequentially and the name of the customer was also printed onto the cloth. The finished cloth was then rolled up and packaged for dispatch to the casino or the company that would install the cloths at the casino.

1. A process for manufacture of a gaming or cue-sports cloth, wherein a cloth containing at least 60% wool and comprising base fibres and surface fibres that form an upper surface of the cloth is bulk dyed to a substantially uniform colour and, in addition, at least some of the surface fibres are provided with a graphic image using ink suitable for wool and blends thereof, by overprinting using a computer controlled digital printer with a travelling print head.

2. A process according to claim 1 in which the ink is selected from the group containing reactive dye, acid dye and pigment.

3. A process according to claim 2 in which the ink is selected from the group containing reactive dye and acid dye.

4. A process according to any preceding claim in which the cloth contains at least about 70% wool.

5. A process according to any preceding claim in which the cloth contains at least about 70%, preferably at least about 80% wool and at most about 30%, preferably at most about 20%, polyamide.

6. A process according to any preceding claim in which the cloth is felted woollen or worsted.

7. A process according to any preceding claim in which the cloth is a felted woven woollen.

8. A process according to any preceding claim in which the dyed cloth is a felted non-woven woollen.

9. A process according to any preceding claim in which the cloth is a worsted cloth.

10. A process according to any preceding claim, including the steps of feeding a bulk dyed woven woollen or worsted cloth or a felted woollen needle fabric to an inkjet printing machine then using the machine to print the top surface of the cloth with ink to generate a graphic design on at least part of the top surface that contrasts visibly with the unprinted bulk dyed cloth, and which fulfils a requestor's expressed design wish.

11. A process according to claim 10 in which a plurality of designs from associated requesters are printed onto discrete areas of a roll of fabric which is then cut to separate the discrete areas, which areas are subsequently distributed to the associated requestors.

12. A process according to any preceding claim, in which the cloth has a finish applied to it after printing.

13. A process according to any preceding claim, in which the cloth is steamed after printing.

14. A cloth made by a process according to any preceding claim.

15. A pool table covered with a cloth according to claim 14, the bulk dyed colour being such that the visibility of cue stabs on the cloth is reduced compared with the visibility for an otherwise identical cloth which has not been bulk dyed before overprinting.

16. Use of a cloth according to claim 14 wherein the surface fibres provide a playing surface for a cue sports table.

17. Use of a cloth according to claim 14 wherein the surface fibres provide a playing surface for a casino table.
